(19) United States
(12) Patent Application Publication
(10) Pub. No.: US 2019/0306516 A1
(43) Pub. Date: Oct. 3, 2019

(54) SYSTEMS AND METHODS FOR INTRA PREDICTION CODING

(71) Applicant: Sharp Kabushiki Kaisha, Sakai City, Osaka (JP)

(72) Inventors: Kiran Mukesh MISRA, Camas, WA (US); Seung-Hwan KIM, Camas, WA (US); Christopher Andrew SEGALL, Camas, WA (US)

(21) Appl. No.: 16/303,159

(22) PCT Filed: Apr. 13, 2017
(86) PCT No.: PCT/JP2017/015163

§ 371 Date: Nov. 20, 2018

Related U.S. Application Data
(60) Provisional application No. 62/341,039, filed on May 24, 2016.

(51) Int. Cl. H04N 19/186; H04N 19/593

(52) U.S. Cl. CPC H04N 19/186; H04N 19/593

(57) ABSTRACT

A video coding device may be configured to perform intra prediction coding according to one or more of the techniques described herein.

### TECHNICAL FIELD

This disclosure relates to video coding and more particularly to techniques for intra prediction coding.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 April 2015, which is incorporated by reference, and referred to herein as ITU-T H.265. Extensions and improvements for ITU-T H.265 are currently being considered for development of next generation video coding standards. For example, the ITU-T Video Coding Experts Group (VCEG) and ISO/IEC (Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 2 (JEM 2), Algorithm Description of Joint Exploration Test Model 2 (JEM 2), ISO/IEC JTC1/SC29/WG11/N16066, February 2016, San Diego, Calif., US, which is incorporated by reference herein, describes the coding features that are under coordinated test model study by the JVET as potentially enhancing video coding technology beyond the capabilities of ITU-T H.265. It should be noted that the coding features of JEM 2 are implemented in JEM reference software maintained by the Fraunhofer research organization. Currently, the updated JEM reference software version 2 (JEM 2.0) is available. As used herein, the term JEM is used to collectively refer to algorithm descriptions of JEM 2 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In general, this disclosure describes various techniques for coding video data. In particular, this disclosure describes techniques for intra prediction video coding. The techniques described herein may be used for deriving cross-component prediction parameters. It should be noted that although techniques of this disclosure are described with respect to ITU-T H.264, ITU-T H.265, and JEM, the techniques of this disclosure are generally applicable to video coding. For example, intra prediction video coding techniques that are described herein with respect to ITU-T H.265 may be generally applicable to video coding. For example, the coding techniques described herein may be incorporated into video coding systems, (including future video coding standards) including block structures, intra prediction techniques, inter prediction techniques, transform techniques, filtering techniques, and/or entropy coding techniques other than those included in ITU-T H.265. Thus, reference to ITU-T H.264, ITU-T H.265, and/or JEM is for descriptive purposes and should not be construed to limit the scope to of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

An aspect of the invention is a method of decoding video data, the method comprising: receiving reconstructed samples of video data; determining an intra prediction parameter for luma component; and reconstructing one or more samples of a chroma component according to a cross-correlation prediction based on the determined intra prediction for the luma component.

### BRIEF DESCRIPTION OF DRAWINGS

FIG. 1 is a block diagram illustrating an example of a system that may be configured to encode and decode video data according to one or more techniques of this disclosure.

FIG. 2 is a block diagram illustrating an example of a video encoder that may be configured to encode video data according to one or more techniques of this disclosure.

FIG. 3 is a conceptual diagram illustrating an example of a video component sampling format that may be utilized in accordance with one or more techniques of this disclosure.

FIG. 4 is a conceptual diagram illustrating examples of a multi-line intra prediction techniques that may be utilized in accordance with one or more techniques of this disclosure.

FIG. 5 is a conceptual diagram illustrating examples of cross component intra prediction techniques that may be utilized in accordance with one or more techniques of this disclosure.

FIG. 6 is a conceptual diagram illustrating examples of cross-component intra prediction techniques that may be utilized in accordance with one or more techniques of this disclosure.

FIG. 7 is a block diagram illustrating an example of a video decoder that may be configured to decode video data according to one or more techniques of this disclosure.

FIG. 8 is a conceptual diagram illustrating examples of cross-component intra prediction techniques that may be utilized in accordance with one or more techniques of this disclosure.

### DESCRIPTION OF EMBODIMENTS

Video content typically includes video sequences comprised of a series of frames. A series of frames may also be referred to as a group of pictures (GOP). Each video frame or picture may include a plurality of slices or tiles, where a slice or tile includes a plurality of video blocks. A video block may be defined an array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. In ITU-T H.265, the CTBs of a CTU may be partitioned into Coding Blocks (CB) according to a corresponding quadtree block structure. According to ITU-T H.265, one luma CB together with two corresponding chroma CBs (e.g., Cr and Cb chroma components) and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples.

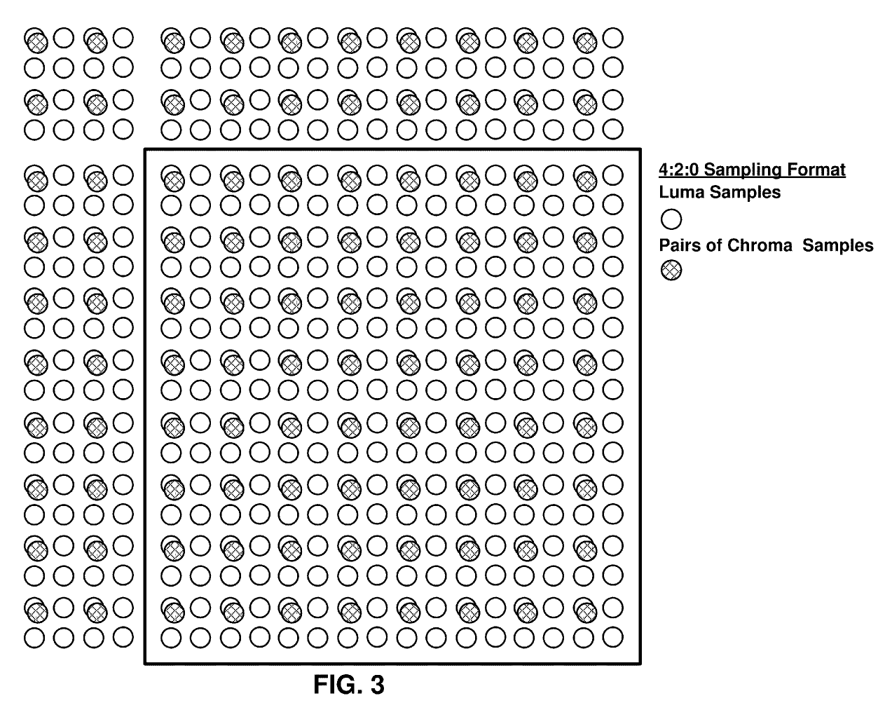

A video sampling format, which may also be referred to as a chroma format, may define the number of chroma samples included in a CU with respect to the number of luma samples included in a CU. For example, for the 4:2:0 format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. FIG. 3 is a conceptual diagram illustrating an example of a 16×16 coding unit formatted according to a 4:2:0 sample format. FIG. 3 illustrates the relative position of chroma samples with respect to luma samples within a CU. As described above, a CU is typically defined according to the number of horizontal and vertical luma samples. Thus, as illustrated in FIG. 3, a 16×16 CU formatted according to the 4:2:0 sample format includes 16×16 samples of luma components and 8×8 samples for each chroma component. Further, in an example, the relative position of chroma samples with respect to luma samples for video blocks neighboring the 16×16 are illustrated in FIG. 3. Similarly, for a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component. JEM specifies a CTU having a maximum size of 256×256 luma samples. In JEM, CTBs may be further partitioned according to a binary tree structure. That is, JEM specifies a quadtree plus binary tree (QTBT) block structure. In JEM, the binary tree structure enables square and rectangular binary tree leaf nodes, which are referred to as Coding Blocks (CBs). In JEM, CBs may be used for prediction without any further partitioning. Further, in JEM, luma and chroma components may have separate QTBT structures. As used herein, the term video block may generally refer to an area of a picture, including one or more components, or may more specifically refer to the largest array of pixel/sample values that may be predictively coded, sub-divisions thereof, and/or corresponding structures. Further, the term current video block may refer to an area of a picture being encoded or decoded.

The difference between sample values included in a PU, CB, or another type of picture area structure and associated reference samples may be referred to as residual data. Residual data may include respective arrays of difference values corresponding to each component of video data (e.g., luma (Y) and chroma (Cb and Cr). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, PUs may be further sub-divided into Transform Units (TUs). That is, an array of pixel difference values may be sub-divided for purposes of generating transform coefficients (e.g., four 8×8 transforms may be applied to a 16×16 array of residual values), such sub-divisions may be referred to as Transform Blocks (TBs). In JEM, residual values corresponding to a CB may be used to generate transform coefficients. Further, in JEM, a core transform and a subsequent secondary transforms may be applied (in the encoder) to generate transform coefficients. For the decoder the order of transforms is reversed. Further, whether a secondary transform is applied to generate transform coefficients may be dependent on a prediction mode.

Transform coefficients may be quantized according to a quantization parameter (QP). Quantized transform coefficients may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

As described above, intra prediction data or inter prediction data may associate an area of a picture (e.g., a PU or a CB) with corresponding reference samples. For intra prediction coding, an intra prediction mode may specify the location of reference samples within a picture. In ITU-T H.265, defined possible intra prediction modes include a planar (i.e., surface fitting) prediction mode (predMode: 0), a DC (i.e., flat overall averaging) prediction mode (predMode: 1), and 33 angular prediction modes (predMode: 2-34). For angular prediction modes, a row of neighboring samples above a PU or CB, a column of neighboring samples to the left of a PU or CB, and an upper-left neighboring sample may be defined. For example, in ITU-T H.265 a row of neighboring samples may include twice as many samples as a row of a PU (e.g., for a 8×8 PU, a row of neighboring samples includes 16 samples) that may be used for generating predictions. In ITU-T H.265, angular prediction modes enable a reference sample to be derived for each sample included in a PU or CB by pointing to samples in the adjacent row of neighboring samples, the adjacent column of neighboring samples, and/or the adjacent upper-left neighboring sample. In JEM, defined possible intra-prediction modes include a planar prediction mode (predMode: 0), a DC prediction mode (predMode: 1), and 65 angular prediction modes (predMode: 2-66). It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes. For example, possible intra prediction modes may include any number of non-directional prediction modes (e.g., two or more fitting or averaging modes) and any number of directional prediction modes (e.g., 35 or more angular prediction modes). In an example, for intra prediction, a block of samples coded in the past within the same frame, may be used as reference to generate a prediction. The location of the reference block of samples may be explicitly signaled or may be derived based on a distortion metric obtained by comparing the neighborhood of samples to be predicted and the block being used for reference.

In current video coding systems implemented based on ITU-T H.265 and/or JEM, for angular prediction modes, the angular prediction mode used for generating predictive samples for a current video block may be selected based on a rate-distortion analysis (i.e., bit-rate vs. quality of video). In current video coding systems an analysis may include analyzing one or more angular prediction modes and the quality of resulting predictive samples generated from the set neighboring samples defined for the current video block, where the set of neighboring samples is limited to immediately adjacent samples. In order to increase the compression capability of ITU-T H.265 and/or JEM, so-call multiple line intra prediction techniques have been proposed. For example, Li et al., “Multiple line-based intra prediction,” Document: JVET-C0071 Joint Video Exploration Team (JVET) of ITU-T SG16 WP3 and ISO/IEC JTC1/SC29/WG11 3rd Meeting: Geneva, CH, 26 May-1 Jun. 2016, (hereinafter “JVET-C0071”), and Chang et al., “Arbitrary reference tier for intra directional modes,” Document: JVET-C0043 Joint Video Exploration Team (JVET) of ITU-T SG16 WP3 and ISO/IEC JTC1/SC29/WG11 3rd Meeting: Geneva, CH, 26 May-1 Jun. 2016, (hereinafter “JVET-C0043”), each of which are incorporated by reference herein, describe multiple line intra-prediction techniques.

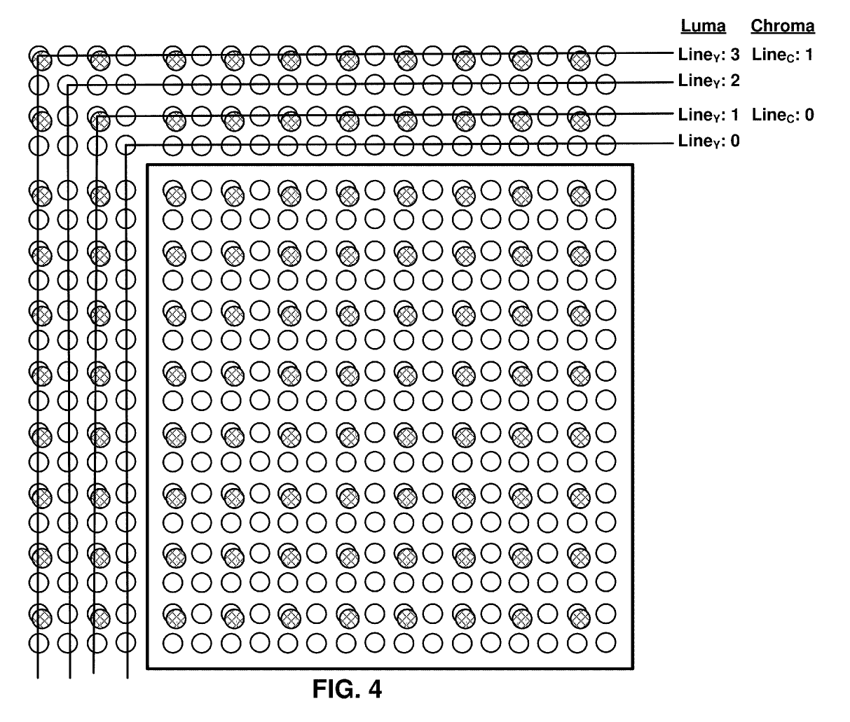

In general, multiple line intra prediction techniques, define one or more respective reference lines that may be used as a set neighboring samples for generating intra prediction samples for a current video block. FIG. 4 illustrates an example where for a 16×16 CU having a 4:2:0 sampling format, four luma reference lines (i.e., Line_{Y}: 0-3) and two chroma reference lines (i.e., Line_{C}: 0-1) are defined. In the case of the example CU illustrated in FIG. 4, for ITU-T H.265 and JEM intra prediction techniques, predictive samples would be limited to samples generated using Line_{Y}: 0 and Line_{C}: 0. JVET-C0071 describes where an encoder checks four luma reference lines for a CU, from the nearest reference line (e.g., Line_{Y} 0 in FIG. 4) to farthest reference line (e.g., Line_{C} 3 in FIG. 4), and chooses the best reference line for intra prediction according to the rate-distortion cost. That is, for example, in the case of a 16×16 CU, in JVET-C0071 one of Line_{Y}: 0-3 would be selected for the CU and the selected line would be used for generating intra prediction samples for the luma component. Further, in JVET-C0071, the chroma components use the reference line index of its corresponding luma component. That is, for the 4:2:0 CU illustrated in FIG. 4, in JVET-C0071, chroma components use Line_{C}: 0 when the luma component uses Line_{Y}: 0 or Line_{Y}: 1 and chroma components use Line_{C}: 1 when the luma component uses Line_{Y}: 2 or Line_{Y}: 3.

In addition to generating reference samples according to the non-directional and/or the angular prediction modes described above, intra prediction coding may include so-called cross component correlation techniques. In general, intra prediction coding techniques including so-called cross component correlation techniques are based on an assumption that for most video codecs chroma sample prediction is performed after the luma sample reconstruction and as such, in these cases, information inferred from reconstructed luma samples can be used for chroma sample prediction. An example of a cross component correlation technique includes the Color Component correlation based prediction (CCCP) technique described in McCann et al., “Samsung's Response to the Call for Proposals on Video Compression Technology,” Document: JCTVC-A124 Joint Collaborative Team on Video Coding (JCT-VC) of ITU-T SG16 WP3 and ISO/IEC JTC1/SC29/WG11 1st Meeting: Dresden DE, 15-23 Apr. 2010, (hereinafter “JCTVC-A124”), which is incorporated by reference herein. Further, JEM provides a cross component prediction technique, which may be referred to as a cross-component Linear Model (LM), for generating predictions for chroma based on reconstructed luma samples. The cross-component prediction technique in JEM is defined according to Equations (1) and (2):

pred_{C}(i,j)=α·rec_{L}(i,j)+β (1)

pred*_{Cr}(i,j)=pred_{Cr}(i,j)+α·resi_{Cb}′(i,j) (2)

where pred_{C}(i,j) represents the prediction of chroma samples in a block at location (i,j) and rec_{L}(i,j) represents the downsampled reconstructed luma samples of the same block at location (i,j) and where parameters alpha(α) and beta(β) are derived by minimizing regression error between the neighboring reconstructed luma and chroma samples around the current block.

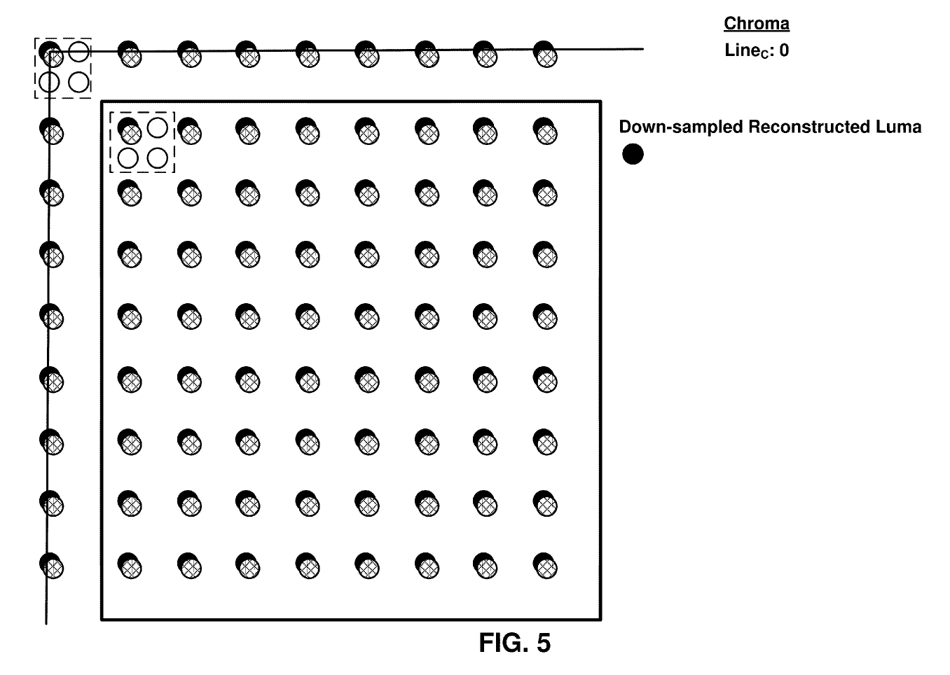

Referring to Equation (2) above, in JEM, the cross-component prediction technique is extended to the prediction between two chroma components. That is, Cr component is predicted from Cb component. Further, as illustrated in Equation (2) instead of using the reconstructed sample signal, the cross component prediction for the Cr component is applied in residual domain, which is implemented by adding a weighted reconstructed Cb residual to the original Cr intra prediction to form the final Cr prediction. FIG. 5 illustrates an example where for a 16×16 CU having a 4:2:0 sampling format, a chroma prediction is based on reconstructed luma samples within the CU and the neighboring reconstructed luma and chroma samples around the current block. As illustrated in FIG. 5, for each chroma sample, a corresponding down-sampled luma value is generated. JCTVC-A124 describes where a bi-linear filter is used to generate down-sampled luma values. In the example illustrated in FIG. 5, each down-sampled luma value is illustrated as being generated based on the four corresponding reconstructed luma samples (illustrated as dashed boxes in FIG. 5).

B. Bross, W.-J. Han, G. J. Sullivan, J.-R. Ohm and T. Wiegand, “High Efficiency Video Coding (HEVC) text specification draft 7”, Joint Collaborative Team on Video Coding (JCT-VC) of ITU-T SG16 WP3 and ISO/IEC JTC1/SC29/WG11, Doc. JCTVC-I1003, 9th Meeting, Geneva, CH, May. 2012 (hereinafter “JCTVC-I1003”), which is incorporated by reference herein describes example techniques for deriving parameters alpha and beta. JCTVC-I1003 defines formulas for various intermediate variables (e.g., L, C, LL, LC, al, etc.) that may be used to derive parameters alpha and beta. For the sake of brevity, a complete description of deriving parameters alpha and beta is not reproduced herein, however, reference is made to relevant sections of JCTVC-I1003. Further, it should be noted that other variations on the techniques described in JCTVC-I1003 for deriving parameters have been described (i.e., changing scaling values in equations for intermediate variables). However, it should be noted that current techniques for deriving parameters alpha and beta are limited to using an immediately adjacent row or column of neighboring chroma values and corresponding down-sampled luma values. It should be noted that parameters alpha and beta and variations thereof may be referred to and/or be examples of cross-component prediction parameters. As such, the term cross-component prediction parameters as used herein may refer to additional cross-component prediction parameters, intermediate variables used to derive parameters alpha and beta, and/or variations of parameters alpha and beta. Further, it should be noted that derivation of cross-component prediction parameters may occur at a video encoder for generating reconstructed reference samples and/or at video decoder for reconstructing video data from a compliant bitstream. Current techniques for deriving cross-component prediction parameters may be less than ideal.

As described above, intra prediction data or inter prediction data may associate an area of a picture (e.g., a PB or a CB) with corresponding reference samples. For inter prediction coding, a motion vector (MV) identifies reference samples in a picture other than the picture of a video block to be coded and thereby exploits temporal redundancy in video. For example, a current video block may be predicted from a reference block located in a previously coded frame and a motion vector may be used to indicate the location of the reference block. A motion vector and associated data may describe, for example, a horizontal component of the motion vector, a vertical component of the motion vector, a resolution for the motion vector (e.g., one-quarter pixel precision), a prediction direction and/or a reference picture index value. Further, a coding standard, such as, for example ITU-T H.265, may support motion vector prediction. Motion vector prediction enables a motion vector to be specified using motion vectors of neighboring blocks. Examples of motion vector prediction include advanced motion vector prediction (AMVP), temporal motion vector prediction (TMVP), so-called “merge” mode, and “skip” and “direct” motion inference. Further, JEM supports advanced temporal motion vector prediction (ATMVP) and Spatial-temporal motion vector prediction (STMVP).

As described above, syntax elements may be entropy coded according to an entropy encoding technique. As described above, a binarization process may be performed on syntax elements as part of an entropy coding process. Binarization is a lossless process and may include one or a combination of the following coding techniques: fixed length coding, unary coding, truncated unary coding, truncated Rice coding, Golomb coding, k-th order exponential Golomb coding, and Golomb-Rice coding. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. After binarization, a CABAC entropy encoder may select a context model. For a particular bin, a context model may be selected from a set of available context models associated with the bin. In some examples, a context model may be selected based on a previous bin and/or values of previous syntax elements. For example, a context model may be selected based on the value of a neighboring intra prediction mode. A context model may identify the probability of a bin being a particular value. For instance, a context model may indicate a 0.7 probability of coding a 0-valued bin and a 0.3 probability of coding a 1-valued bin. After selecting an available context model, a CABAC entropy encoder may arithmetically code a bin based on the identified context model. It should be noted that some syntax elements may be entropy encoded using arithmetic encoding without the usage of an explicitly assigned context model, such coding may be referred to as bypass coding.

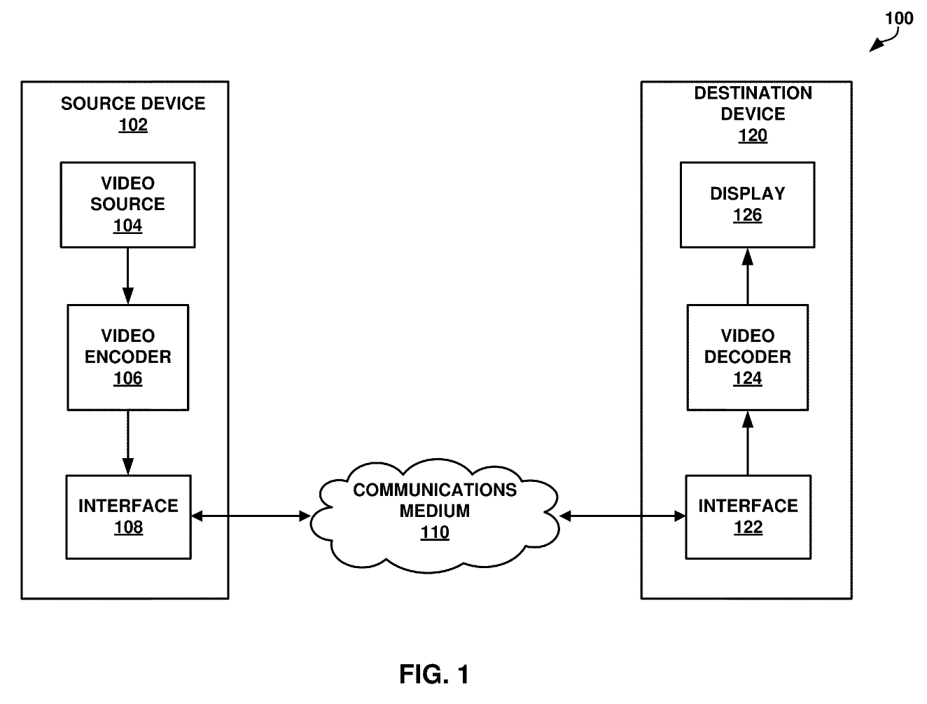

FIG. 1 is a block diagram illustrating an example of a system that may be configured to code (i.e., encode and/or decode) video data according to one or more techniques of this disclosure. System 100 represents an example of a system that may derive cross-component prediction parameters according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 1, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

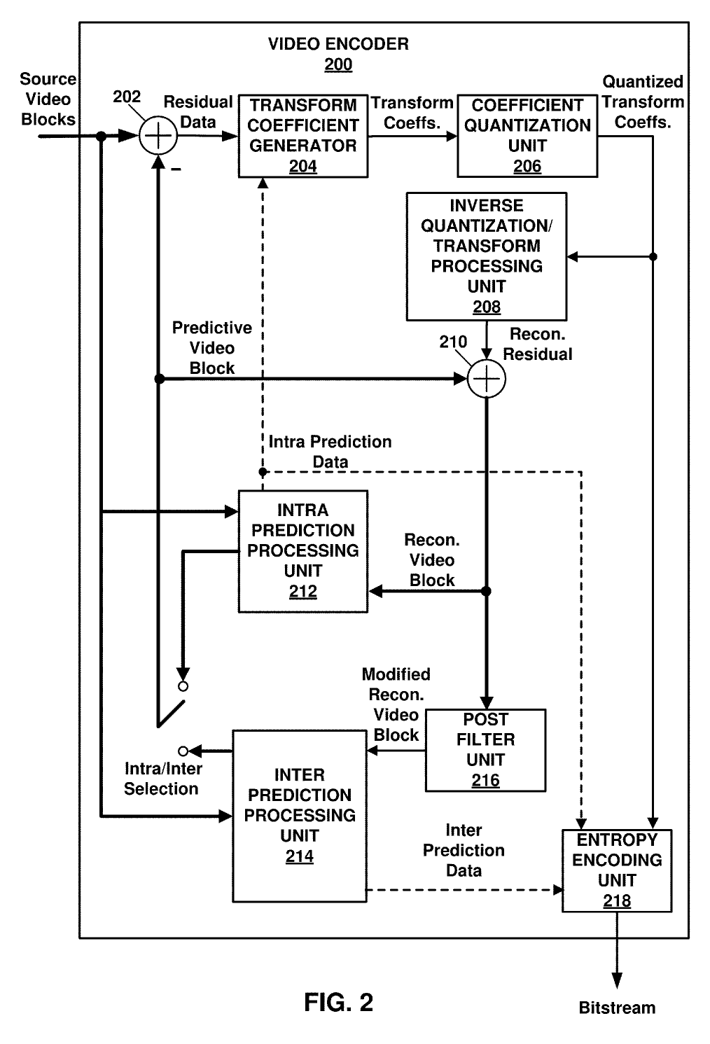

FIG. 2 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the intra prediction techniques described herein. Video encoder 200 may perform intra prediction coding and inter prediction coding of picture areas, and, as such, may be referred to as a hybrid video encoder. In the example illustrated in FIG. 2, video encoder 200 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder may be configured to perform additional sub-divisions of source video blocks. It should be noted that the techniques described herein are generally applicable to video coding, regardless of how source video data is partitioned prior to and/or during encoding. In the example illustrated in FIG. 2, video encoder 200 includes summer 202, transform coefficient generator 204, coefficient quantization unit 206, inverse quantization/transform processing unit 208, summer 210, intra prediction processing unit 212, inter prediction processing unit 214, post filter unit 216, and entropy encoding unit 218. As illustrated in FIG. 2, video encoder 200 receives source video blocks and outputs a bitstream.

In the example illustrated in FIG. 2, video encoder 200 may generate residual data by subtracting a predictive video block from a source video block. The selection of a predictive video block is described in detail below. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. Transform coefficient generator 204 may output transform coefficients to coefficient quantization unit 206. Coefficient quantization unit 206 may be configured to perform quantization of the transform coefficients. The quantization process may reduce the bit depth associated with some or all of the coefficients. The degree of quantization may alter the rate-distortion of encoded video data. The degree of quantization may be modified by adjusting a quantization parameter (QP). As illustrated in FIG. 2, quantized transform coefficients are output to inverse quantization/transform processing unit 208. Inverse quantization/transform processing unit 208 may be configured to apply an inverse quantization and an inverse transformation to generate reconstructed residual data. As illustrated in FIG. 2, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 2, intra prediction processing unit 212 outputs intra prediction data (e.g., syntax elements) to entropy encoding unit 220 and transform coefficient generator 204. As described above, a transform performed on residual data may be mode dependent. As described above, possible intra prediction modes may include planar prediction modes, a DC prediction modes, and angular prediction modes. Further, as described above, possible intra prediction techniques may include multiple line intra prediction techniques. Further, as described above, in some examples, a prediction for a chroma component may be inferred from an intra prediction for a luma prediction mode. In one example, intra prediction processing unit 212 may select an intra prediction mode and a reference line (in the case of multiple line intra predictions) for a luma component after performing one or more coding passes. Further, in one example, intra prediction processing unit 212 may select a luma component prediction mode and a reference line based on a rate-distortion analysis and chroma component predictions may be based on the selected luma component prediction mode and a reference line. In one example, intra prediction processing unit 212 may select an intra prediction mode and a reference line (in the case of multiple line intra predictions) for a luma component after performing one or more coding passes. Further, in one example, intra prediction processing unit 212 may select a luma component prediction mode and a reference line based on a rate-distortion analysis and chroma component predictions may be based on the selected luma component reference line.

In one example, according to the techniques described herein, intra prediction processing unit 212 may be configured to generate a set of reference lines used for possible multiple line intra predictions. In one example, a set of reference lines used for possible multiple line intra predictions may include a set of reference lines other than a set including immediately adjacent lines (e.g., other than the nearest neighboring four lines). In one example, a set of reference lines may be defined as including every i-th line, where i equal 2, 3, 4 . . . 64, etc. (e.g., every other neighboring line, or every 4, 8, or 16 neighboring line, etc.). Further, in one example, a set of reference lines may be determined based on sample values included in neighboring lines. For example, if two possible reference lines include similar sample values, one of the lines may be replaced with another line in a set of neighboring reference lines (e.g., neighboring line 3 may be replaced by neighboring line 7, if it is similar to neighboring line 2). That is, according to the techniques described herein, a pruning process may be used to generate a set of reference lines for multiple line intra predictions.

In one example, according to the techniques described herein, intra prediction processing unit 212 may be configured to use a multiple line intra prediction technique for a luma component and use a cross-correlation prediction (e.g., a cross correlation prediction described above) for chroma components. In one example, according to the techniques described herein, intra prediction processing unit 212 may be configured to derive cross-component prediction parameters for both or each respective chroma component based on available reconstructed luma samples, including neighboring reconstructed luma samples, and available reconstructed chroma samples, including neighboring samples that are not limited to immediately adjacent neighboring samples, and/or one or more luma component prediction properties (e.g., luma prediction modes and/or reference lines used for luma prediction modes). Further, it should be noted that in the case of the 4:2:0 sampling format, intra prediction processing unit 212 may be configured to be generate down-sampled luma values corresponding to chroma sample values using additional filtering techniques, (e.g., Gaussian filters, etc.), where filtering techniques may be based on luma component prediction properties. It should be noted that although the techniques described herein are described with respect to examples using the 4:2:0 sampling format, the techniques described herein may be generally applicable to the 4:2:2 and 4:4:4 sampling formats described above and other sampling formats. Further, it should be noted that although the examples described herein are describe with respect to square CUs, the techniques described herein may be generally applicable to cases where predictions are based on rectangular partitions. Further, it should be noted that the techniques described herein may be generally applicable to cases where partitioning of samples in luma and chroma components may be independent of each other. Further, it should be noted that the techniques described herein may be generally applicable to cases where partitioning of samples in each component may be independent of the other component.

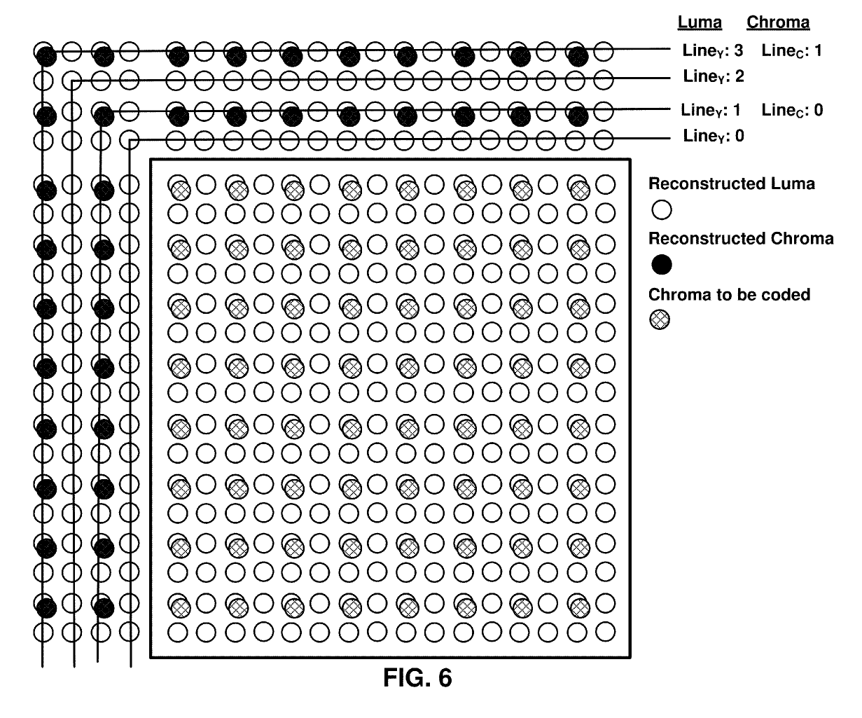

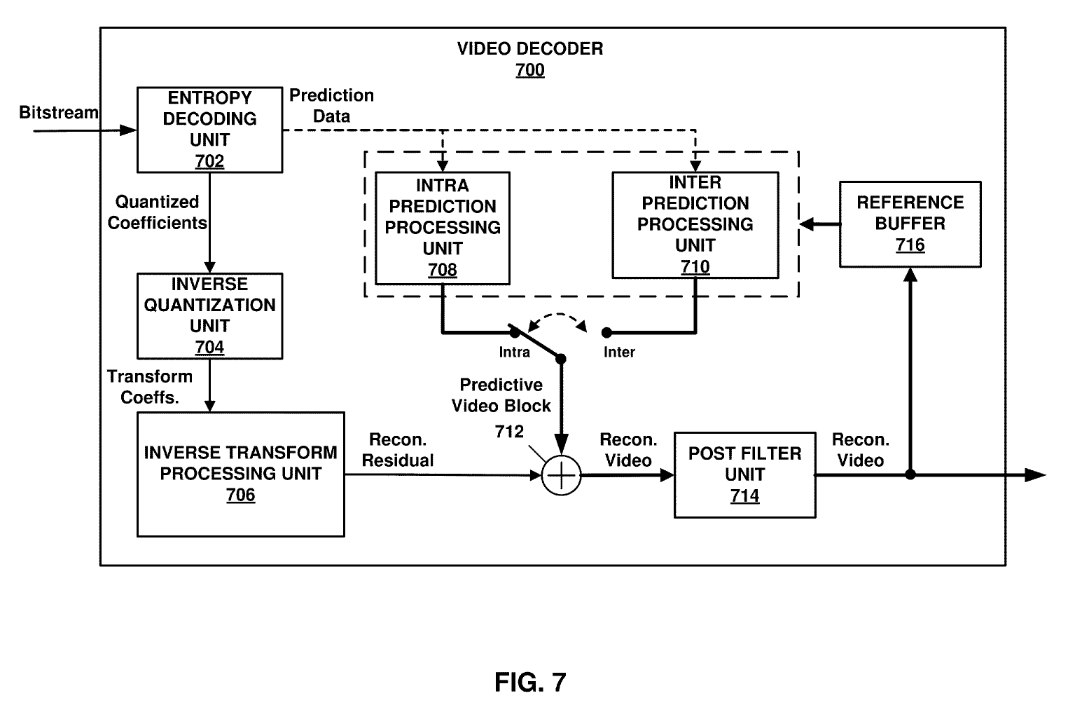

As described above, current techniques for deriving cross-component prediction parameters may be less than ideal. As further described above, the derivation of cross-component prediction parameters may occur at a video encoder for generating reconstructed reference samples and/or at video decoder for reconstructing video data from a compliant bitstream. Referring to FIG. 6, FIG. 6 illustrates an example where for a 16×16 CU, neighboring luma and/or chroma samples have been reconstructed and a luma component for has been reconstructed, where the luma component was predicted using a multiple line prediction. Thus, in the example illustrated in FIG. 6, for the current CU, with respect to video encoding, neighboring reconstructed luma and/or chroma samples, a reconstructed luma component for the current CU, and multiple line prediction parameters may be available for encoding the chroma components in the current CU and similarly, in one example, a video decoder may derive cross-correlation parameters for decoding the chroma components in the current CU from neighboring reconstructed luma and/or chroma samples, a reconstructed luma component for the current CU, and multiple line prediction parameters. Derivation of cross-correlation parameters according to the techniques described herein is described with respect to video decoder 700 illustrated in FIG. 7.

In an example, with respect to video encoding, neighboring reconstructed luma and/or chroma samples, a reconstructed luma component for the current CU, dimensions of the chroma block, chroma format and multiple line prediction parameters may be available for encoding the chroma components, in one example, a video decoder may derive cross-correlation parameters for decoding the chroma components in the current CU from neighboring reconstructed luma and/or chroma samples, a reconstructed luma component for the current CU, dimensions of the chroma block, chroma format and multiple line prediction parameters.

Referring again to FIG. 2, inter prediction processing unit 214 may be configured to perform inter prediction coding for a current video block. Inter prediction processing unit 214 may be configured to receive source video blocks and calculate a motion vector for PUs of a video block. A motion vector may indicate the displacement of a PU of a video block within a current video frame relative to a predictive block within a reference frame. Inter prediction coding may use one or more reference pictures. Further, motion prediction may be uni-predictive (use one motion vector) or bipredictive (use two motion vectors). Inter prediction processing unit 214 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 214 may be configured to perform motion vector prediction, as described above. Inter prediction processing unit 214 may be configured to generate a predictive block using the motion prediction data. For example, inter prediction processing unit 214 may locate a predictive video block within a frame buffer (not shown in FIG. 2). It should be noted that inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to entropy encoding unit 218. As illustrated in FIG. 2, inter prediction processing unit 214 may receive reconstructed video block via post filter unit 216. Post filter unit 216 may be configured to perform deblocking and/or Sample Adaptive Offset (SAO) filtering. Deblocking refers to the process of smoothing the boundaries of reconstructed video blocks (e.g., make boundaries less perceptible to a viewer). SAO filtering is a non-linear amplitude mapping that may be used to improve reconstruction by adding an offset to reconstructed video data.

Referring again to FIG. 2, entropy encoding unit 218 receives quantized transform coefficients and predictive syntax data (i.e., intra prediction data and motion prediction data). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom. It should be noted that in some examples, a compliant bitstream may signal variables that may be used by a decoder to derive cross-correlation parameters. In some examples, cross-correlation parameters may be derived based on reconstructed video data.

FIG. 7 is a block diagram illustrating an example of a video decoder that may be configured to decode video data according to one or more techniques of this disclosure. In one example, video decoder 700 may be configured to decode intra prediction data. In one example, video decoder 700 may be configured to derive cross-correlation parameters for decoding the chroma components in the current CU from neighboring reconstructed luma and/or chroma samples, a reconstructed luma component for the current CU, and multiple line prediction parameters. Video decoder 700 may be configured to perform intra prediction decoding and inter prediction decoding and, as such, may be referred to as a hybrid decoder. In the example illustrated in FIG. 7 video decoder 700 includes an entropy decoding unit 702, inverse quantization unit 704, inverse transformation processing unit 706, intra prediction processing unit 708, inter prediction processing unit 710, summer 712, post filter unit 714, and reference buffer 716. Video decoder 700 may be configured to decode video data in a manner consistent with a video encoding system, which may implement one or more aspects of a video coding standard. It should be noted that although example video decoder 700 is illustrated as having distinct functional blocks, such an illustration is for descriptive purposes and does not limit video decoder 700 and/or sub-components thereof to a particular hardware or software architecture. Functions of video decoder 700 may be realized using any combination of hardware, firmware, and/or software implementations.

As illustrated in FIG. 7, entropy decoding unit 702 receives an entropy encoded bitstream. Entropy decoding unit 702 may be configured to decode quantized syntax elements and quantized coefficients from the bitstream according to a process reciprocal to an entropy encoding process. Entropy decoding unit 702 may be configured to perform entropy decoding according any of the entropy coding techniques described above. Entropy decoding unit 702 may parse an encoded bitstream in a manner consistent with a video coding standard.

Referring again to FIG. 7, inverse quantization unit 704 receives quantized transform coefficients from entropy decoding unit 702. Inverse quantization unit 704 may be configured to apply an inverse quantization. Inverse transform processing unit 706 may be configured to perform an inverse transformation to generate reconstructed residual data. The techniques respectively performed by inverse quantization unit 704 and inverse transform processing unit 706 may be similar to techniques performed by inverse quantization/transform processing unit 208 described above. Inverse transform processing unit 706 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether particular transform (or type of particular transform) is performed may be dependent on an intra prediction mode. As illustrated in FIG. 7, reconstructed residual data may be provided to summer 712. Summer 712 may add reconstructed residual data to a predictive video block and generate reconstructed video data. A predictive video block may be determined according to a predictive video technique (i.e., intra prediction and inter frame prediction).

Intra prediction processing unit 708 may be configured to receive intra prediction syntax elements and retrieve a predictive video block from reference buffer 716. Reference buffer 716 may include a memory device configured to store one or more frames of video data. Intra prediction syntax elements may identify an intra prediction mode, such as the intra prediction modes described above. In one example, intra prediction processing unit 708 may reconstruct a video block using according to one or more of the intra prediction coding techniques describe herein. Referring to FIG. 6, for a current CU, neighboring reconstructed luma and/or chroma samples, a reconstructed luma component for the current CU, and multiple line prediction parameters may be available for decoding the chroma components in the current CU, and as such in one example, intra prediction processing unit 708 may be configured to derive cross-correlation parameters for decoding the chroma components in the current CU from neighboring reconstructed luma and/or chroma samples, a reconstructed luma component for the current CU, and multiple line prediction parameters.

In one example, intra prediction processing unit 708 may be configured to derive cross-correlation parameters based on a reference line selected for the luma component intra prediction. For example, an array of neighboring samples and/or subsets thereof used to derive cross-correlation parameters may be based on a selected reference line used for the intra prediction of luma. Referring to FIG. 6, in one example, intra prediction processing unit 708 may be configured to derive cross-correlation parameters based on the following logical conditions:
If the luma intra prediction has a reference line equal to Line_{Y}: 0, Cross-correlation parameters are a function of Line_{Y}: 0,1 and Line_{C}: 0;
If the luma intra prediction has a reference line equal to Line_{Y}: 1, Cross-correlation parameters are a function of Line_{Y}: 0,1 and Line_{C}: 0;
If the luma intra prediction has a reference line equal to Line_{Y}: 2, Cross-correlation parameters are a function of Line_{Y}: 2,3 and Line_{C}: 1;
If the luma intra prediction has a reference line equal to Line_{Y}: 3, Cross-correlation parameters are a function of Line_{Y}: 2,3 and Line_{C}: 1;

Further, in one example, intra prediction processing unit 708 may be configured to derive cross-correlation parameters based on the following logical conditions:
If the luma intra prediction has a reference line equal to Line_{Y}: 0, Cross-correlation parameters are a function of Line_{Y}: 0,1 and Line_{C}: 0;
If the luma intra prediction has a reference line equal to Line_{Y}: 1, Cross-correlation parameters are a function of Line_{Y}: 1,2 and Line_{C}: 0;
If the luma intra prediction has a reference line equal to Line_{Y}: 2, Cross-correlation parameters are a function of Line_{Y}: 1,2 and Line_{C}: 1;
If the luma intra prediction has a reference line equal to Line_{Y}: 3, Cross-correlation parameters are a function of Line_{Y}: 2,3 and Line_{C}: 1;

Further, in one example, intra prediction processing unit 708 may be configured to derive cross-correlation parameters based on the following logical conditions:
If the luma intra prediction has a reference line for luma equal to Line_{Y: 0}, and reference line for chroma equal to Line_{C}: 0 Cross-correlation parameters are a function of Line_{Y}: 0,1 and Line_{C}: 0;
If the luma intra prediction has a reference line for luma equal to Line_{Y}: 1, and reference line for chroma equal to Line_{C}: 0 Cross-correlation parameters are a function of Line_{Y}: 1,2 and Line_{C}: 0;
If the luma intra prediction has a reference line for luma equal to Line_{Y}: 2, and reference line for chroma equal to Line_{C}: 1 Cross-correlation parameters are a function of Line_{Y}: 1,2 and Line_{C}: 1;
If the luma intra prediction has a reference line for luma equal to Line_{Y}: 3, and reference line for chroma equal to Line_{C}: 1 Cross-correlation parameters are a function of Line_{Y}: 2,3 and Line_{C}: 1;

Further, in one example, intra prediction processing unit 708 may be configured to derive cross-correlation parameters based on the following logical conditions:
If the luma intra prediction has a reference line equal to Line_{Y}: 0, Cross-correlation parameters are a function of Line_{Y}: 0,1 and Line_{C}: 0;
If the luma intra prediction has a reference line equal to Line_{Y}: 1, Cross-correlation parameters are a function of Line_{Y}: 0,1 and Line_{C}: 0;
If the luma intra prediction has a reference line equal to Line_{Y}: 2, Cross-correlation parameters are a function of Line_{Y}: 2,3 and Line_{C}: 0,1;
If the luma intra prediction has a reference line equal to Line_{Y}: 3, Cross-correlation parameters are a function of Line_{Y}: 2,3 and Line_{C}: 0,1;

Further, in one example, intra prediction processing unit 708 may be configured to derive cross-correlation parameters based on the following logical conditions:
If the luma intra prediction has a reference line equal to Line_{Y}: 0, and reference line for chroma equal to Line_{C}: 0, Cross-correlation parameters are a function of Line_{Y}: 0 and Line_{C}: 0;
If the luma intra prediction has a reference line equal to Line_{Y}: 1, and reference line for chroma equal to Line_{C}: 0, Cross-correlation parameters are a function of Line_{Y}: 1 and Line_{C}: 0;
If the luma intra prediction has a reference line equal to Line_{Y}: 2, and reference line for chroma equal to Line_{C}: 1, Cross-correlation parameters are a function of Line_{Y}: 2 and Line_{C}: 1;
If the luma intra prediction has a reference line equal to Line_{Y}: 3, and reference line for chroma equal to Line_{C}: 1, Cross-correlation parameters are a function of Line_{Y}: 3 and Line_{C}: 1;

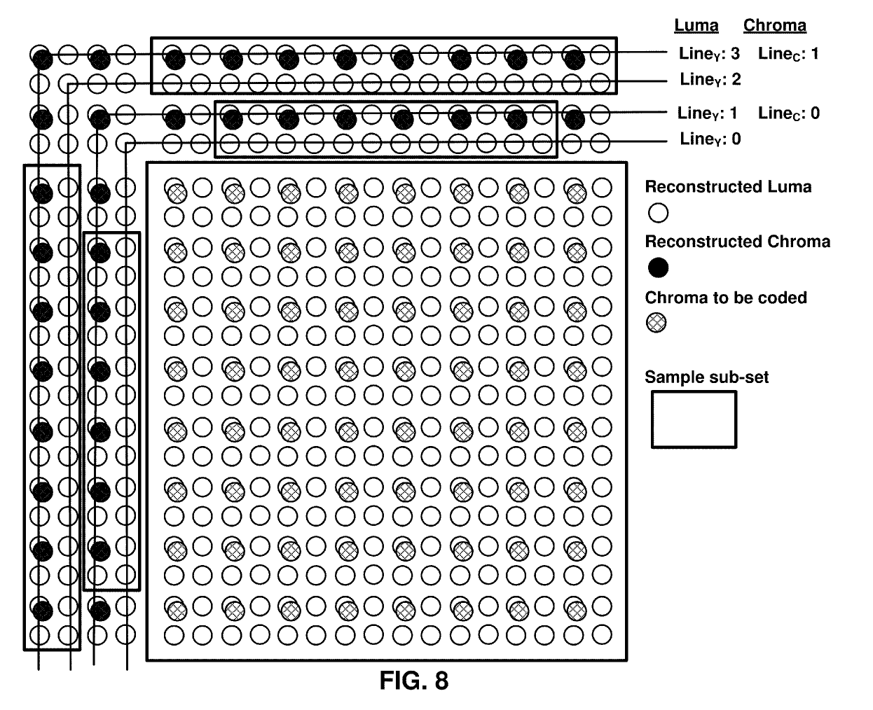

Further, in some examples, intra prediction processing unit 708 may be configured to derive cross-correlation parameters based on a subset of sample values included in one or more lines of neighboring samples. FIG. 8 illustrates an example of subsets of samples in neighboring lines. In the example illustrated in FIG. 8, when cross-correlation parameters are a function of Line_{Y}: 0,1 and Line_{C}: 0 (e.g., according to any of the example logical conditions provided above), 12 columns of luma samples and corresponding chroma samples may be used for deriving cross-correlation parameters and when cross-correlation parameters are a function of Line_{Y}: 2,3 and Line_{C}: 1, 16 columns of luma samples and corresponding chroma samples may be used for deriving cross-correlation parameters. It should be noted that in other examples, other sub-sets of samples may be derived in a similar manner. Further, as described above, in some examples, non-square blocks may be used for partitioning of video data and/or for intra predictions in some examples, sub-sets of samples may be based on whether a block is a square or a non-square (i.e., non-square blocks may have narrower and/or shorter sub-sets of samples).

In one example, intra prediction processing unit 708 may be configured to derive cross-correlation parameters based on sub-sets of samples based on the following logical conditions:
If the luma intra prediction has a reference line equal to Line_{Y}: 0, Cross-correlation parameters are a function of Line_{Y}: 0,1 and Line_{C}: 0, subset 0;
If the luma intra prediction has a reference line equal to Line_{Y}: 1, Cross-correlation parameters are a function of Line_{Y}: 0,1 and Line_{C}: 0, subset 1;
If the luma intra prediction has a reference line equal to Line_{Y}: 2, Cross-correlation parameters are a function of Line_{Y}: 2,3 and Line_{C}: 0,1, subset 2;
If the luma intra prediction has a reference line equal to Line_{Y}: 3, Cross-correlation parameters are a function of Line_{Y}: 2,3 and Line_{C}: 0,1, subset 3;

where, each of subsets 0-3 may include any and all combinations of samples included in reference lines and/or in available reconstructed samples.

In one example, intra prediction processing unit 708 may be configured to derive down-sampled reconstructed luma samples, and reconstructed chroma samples. The dimensions of the non-square chroma prediction unit may then be used to further subsample the down-sampled reconstructed luma samples, and reconstructed chroma samples. These sub-sampled samples may then be used to derive the cross-correlation parameters. In one example, the sub-sampling would be done for the longer edge, the step size would be dimension of longer edge divided by the dimension of shorter edge. It should be noted that reconstructed samples may include filtered reconstructed samples.

Referring again to FIG. 7, inter prediction processing unit 710 may receive inter prediction syntax elements and generate motion vectors to identify a prediction block in one or more reference frames stored in reference buffer 716. Inter prediction processing unit 710 may produce motion compensated blocks, possibly performing interpolation based on interpolation filters. Identifiers for interpolation filters to be used for motion estimation with sub-pixel precision may be included in the syntax elements. Inter prediction processing unit 710 may use interpolation filters to calculate interpolated values for sub-integer pixels of a reference block. Post filter unit 714 may be configured to perform filtering on reconstructed video data. For example, post filter unit 714 may be configured to perform deblocking and/or SAO filtering, as described above with respect to post filter unit 216. Further, it should be noted that in some examples, post filter unit 714 may be configured to perform proprietary discretionary filter (e.g., visual enhancements). As illustrated in FIG. 7, a reconstructed video block may be output by video decoder 700. In this manner, video decoder 700 may be configured to generate reconstructed video data according to one or more of the techniques described herein. In this manner video decoder 700 may be configured to receive reconstructed samples of video data, determine an intra prediction parameter for a luma component, reconstruct one or more samples of a chroma component according to a cross-correlation prediction based on the determined intra prediction for the luma component.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

<Overview>

In one example, a method of coding video data, comprises receiving reconstructed samples of video data, determining an intra prediction parameter for a luma component, reconstructing one or more samples of a chroma component according to a cross-correlation prediction based on the determined intra prediction for the luma component.

In one example, a device for video coding comprises one or more processors configured to receive reconstructed samples of video data, determine an intra prediction parameter for a luma component, reconstruct one or more samples of a chroma component according to a cross-correlation prediction based on the determined intra prediction for the luma component.

In one example, a non-transitory computer-readable storage medium comprises instructions stored thereon that, when executed, cause one or more processors of a device to receive reconstructed samples of video data, determine an intra prediction parameter for a luma component, reconstruct one or more samples of a chroma component according to a cross-correlation prediction based on the determined intra prediction for the luma component.

In one example, an apparatus comprises means for receiving reconstructed samples of video data, means for determining an intra prediction parameter for a luma component, means for reconstructing one or more samples of a chroma component according to a cross-correlation prediction based on the determined intra prediction for the luma component.

The details of one or more examples are set forth in the accompanying drawings and the description below. Other features, objects, and advantages will be apparent from the description and drawings, and from the claims.

### CROSS REFERENCE

This Nonprovisional application claims priority under 35 U.S.C. § 119 on provisional Application No. 62/341,039 on May 24, 2016, the entire contents of which are hereby incorporated by reference.

1.-10. (canceled)

11. A method of decoding video data, the method including:
receiving reconstructed samples of video data;
determining a first parameter for luma component for intra prediction, which includes a multiple-line intra prediction;
determining a set of chroma sample values responsive to the first parameter; and
reconstructing one or more samples for chroma component according to a cross-correlation prediction based on the first parameter and the set of chroma sample values.

12. The method of claim 11, wherein the one or more samples for the chroma component includes one or more cross-correlation parameters based on a reference line determined by the multiple-line intra prediction.

13. The method of claim 12, wherein the one or more cross-correlation parameters includes one or more cross-correlation parameters based on available sample values.

14. A method for coding video data, the method including:
encoding reconstructed samples of video data, wherein the encoding reconstructed samples includes:
encoding a first parameter for luma component for intra prediction, wherein the intra prediction includes a multiple-line intra prediction; and
encoding a set of chroma sample values responsive to the encoded intra prediction for the luma component; and
encoding reconstructed one or more samples for chroma component according to a cross-correlation prediction based on the first parameter and the set of chroma sample values.

15. The method of claim 14, wherein the he reconstructed one or more samples for the chroma component includes one or more cross-correlation parameters based on a reference line encoded by the multiple-line intra prediction.

16. The method of claim 15, wherein the one or more cross-correlation parameters includes one or more cross-correlation parameters based on available sample values.

17. A system comprising:
an encoder apparatus and a decoder apparatus, wherein
the encoder apparatus comprises:
receiving reconstructed samples of video data;
determining a first parameter for luma component for intra prediction, which includes a multiple-line intra prediction;
determining a set of chroma sample values responsive to the first parameter; and
encoding reconstructed one or more samples for chroma component according to a cross-correlation prediction based on the first parameter and the set of chroma sample values, and
the decoder apparatus for decoding the reconstructed one or more samples for chroma component.

18. An apparatus for decoding video data, the apparatus comprising means for performing any and all combinations of the steps of claim 11.

19. An apparatus for coding video data, the apparatus comprising means for performing any and all combinations of the steps of claim 14.

20. A non-transitory computer-readable storage medium comprising instructions stored thereon that, when executed, cause one or more processors of a device for decoding video data to perform any and all combinations of the steps of claim 11.
